(19) United States
(12) Patent Application Publication
(10) Pub. No.: US 2024/0130920 A1
(43) Pub. Date: Apr. 25, 2024

(54) INDOOR ROLLATOR WITH RISE-UP STRUCTURE

(71) Applicant: Topro Industri AS, Gjøvik (NO)

(72) Inventor: Arne Olav EIDE, Gjøvik (NO)

(21) Appl. No.: 18/277,629

(22) PCT Filed: Feb. 17, 2022
(86) PCT No.: PCT/NO2022/050043

§ 371 Date: Aug. 16, 2023

(30) Foreign Application Priority Data
Feb. 19, 2021 (NO) 20210209

(51) Int. Cl. A61H 3/04

(52) U.S. Cl. CPC A61H 3/04; A61H 2003/046; A61H 2201/0161; A61H 2201/0192; A61H 2201/1635

(57) ABSTRACT

An indoor rollator having walking handles with free space between them and having wheels with a parking brake at the rear or legs at the rear, is described, wherein one or more stowable rise-up structures are positioned, when extended in an active position, within a defined rise-up structure volume, VR, wherein the one or more rise-up structure is positioned, when stowed in a retracted position, outside a defined walking volume, VW.

### FIELD OF INVENTION

This invention relates to support materials for elderly persons, disabled persons or people with a chronic decease, more specifically to an indoor rollator with rise-up handles towards the walking side of the rollator.

### BACKGROUND OF THE INVENTION

The number and percentage of people using walking aids is increasing in most parts of the world, and the quality of life for these users depends on various support materials. Rollators are one of the most important ones and enables the users to remain independent and carry out everyday tasks like shopping and move around according to own free will.

As users become more numerous and institutions for elderly become crowded, the local authorities and elderly and handicapped people themselves prefer that the users stay at home as long as possible. The inventors have developed an indoor, lightweight, four-wheel rollator to be used inside ordinary homes which are not furnished with the use of wheelchairs or rollators in mind.

One of the problems is getting up from a chair. People with reduced strength or balance can have trouble getting up from a seated position. Often elderly people have one chair which is used most of the time because that is the chair, they are able to rise up from. Also, a toilet seat and a chair without armrests can be difficult to get up from.

Use of the armrests on chairs in combination with the walking handles on a rollator is a suggested approach by ergo therapists/physiotherapists. This provides one hand on the armrest (close to the body for good force transfer), and one balancing hand further to the front of the user's center of gravity (COG). As the user stands up the COG is shifted towards the rollator. During rise-up the COG ends up between the two supports, which is optimal for balance.

For the rollator to function well inside an ordinary home the rollator must be small, compact and lightweight. This is somewhat contradictive to the requirement of stability. Due to the stability requirements for this type of product, the rise-up handles must be placed a distance from the sides of the product. This leads to a relatively narrow space between the two handles and walking becomes difficult. The invention solves these problems to some extent.

Document 2012/042918 A1 discloses a walking stick or crutch with a fold-out structure. The stick is not sufficiently supported to be used for supporting a user from getting up from a seated position. Document WO 2018/014139 A1 disclose an wheelchair with handles for the user to get up from the wheelchair itself, however, the document is silent regarding any aid relate to getting up from another seat. Document EP 2853249 A1 discloses a solution wherein a user can be aided in getting up from a seated position by folding down an additional sets of legs with handles. The handles 21 are in line with the handles of the walking aid and adds a significant weight and unwanted parts to the walking aid.

### BRIEF SUMMARY OF THE INVENTION

The invention describes an indoor rollator having walking handles with free space between them and having wheels with a parking brake at the rear or legs at the rear. One or more stowable rise-up structures are positioned, when extended in an active position, within a rise-up handle volume, VR, defined by being:
higher than 45 cm above the floor,
lower than 75 cm above the floor,
in front of a vertical plane A extending from the center of rear legs/wheels of the rollator,
rearward of a vertical plane B stretching from the center of two walking handles, and
Inside of vertical planes C and D, which are 3 cm on the inside of a vertical plane extending from the center of the rear leg/wheel and the front wheel on each side, and
wherein the rise-up structures are positioned, when stowed in a retracted position, outside a walking volume, VW, defined by being:
rearward of the vertical plane B stretching from the center of two walking handles,
Inside of vertical planes C and D, which are 3 cm on the inside of a vertical plane extending from the center of the rear leg/wheel and the front wheel on each side.

### BRIEF DESCRIPTION OF THE SEVERAL VIEWS OF THE DRAWING(S)

For a better understanding of the invention, we have made some drawings showing some embodiments of the invention. In these figures, the same reference numerals refer to the same features in different figures.

FIGS. 1a and b shows the rollator with the rise-up handle retracted and extended respectively.

FIG. 2 shows two embodiments of gripping structures at the outer end of the rise-up handles.

FIG. 3 shows an embodiment of a telescopic structure and a click-in system.

FIG. 4 shows use of a rollator according to the invention from above

FIG. 5 shows use of a rollator according to the invention from the side.

FIGS. 6a and b shows the rise-up handle volume and the walking volume.

FIGS. 7a and b shows a rise-up bar in active and stowed position.

FIGS. 8a and b shows a rise-up bar mounted on a telescopic structure.

FIGS. 9a and b shows a foldable handle in active and stowed position.

### DETAILED DESCRIPTION OF THE INVENTION

In this text we define forward and rearward according to the ordinary walking direction of the rollator 1 and we assume the rollator is standing upright when talking about height.

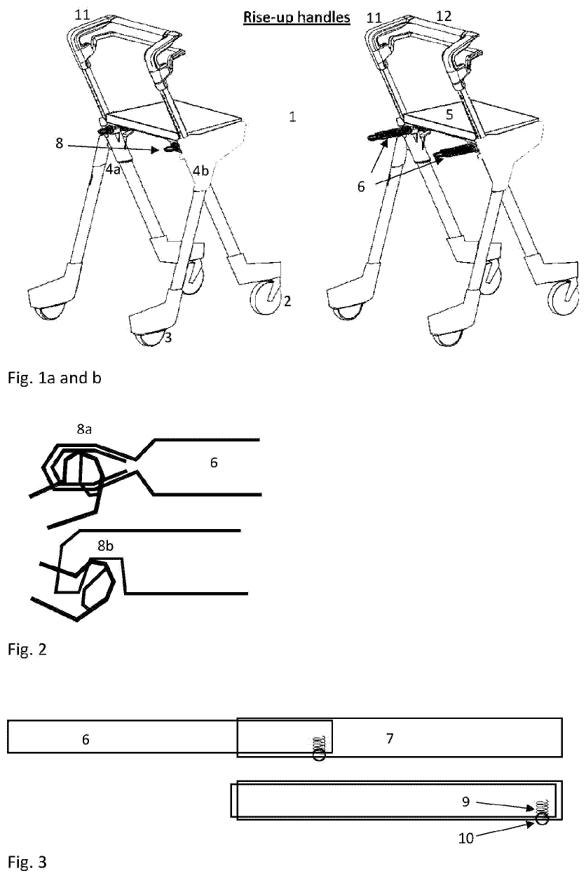

The invention is an indoor rollator 1 with one or more stowable rise-up structures 6 as seen in the drawings. Usually an indoor rollator has four wheels as seen in FIGS. 1a and b, but other embodiments are possible. Three wheels with one wheel in the front is not uncommon, and in US an embodiment having legs instead of wheels at the rear is popular. The legged version improves stability and reduces costs, but also reduces speed and increases the energy needed to move around. In the four wheel/leg scenario, the rollator has two sides, 4a and 4b, each with a rear wheel 2 or leg and a front wheel 3. In the three-wheel version the two sides will share the same front wheel. In the four wheel version the two sides are connected with a bridging structure 5 having the purpose of keeping the rollator rigid and robust.

Since the rollator 1 is meant for use inside ordinary homes the width of the rollator is less than ordinary rollators and if the rise-up structures 6 of the rollator are to stay within the stability requirements laid down by ISO 11199-2 the rise-up structures must be mounted a certain distance from the sides, or more precisely a distance towards the center of the rollator from the vertical plane rising from the straight line between the front 3 and rear 2 wheels. The result of this is that the rise-up structures must be positioned such that walking is hindered. Therefor the rise-up structures have an active extended position for rise-up situations and a stowed passive position for walking. Obviously rise-up structures can be useful on wider rollators as well, but if the rollator is wider, fixed rise-up handles will not hinder walking to the same extent.

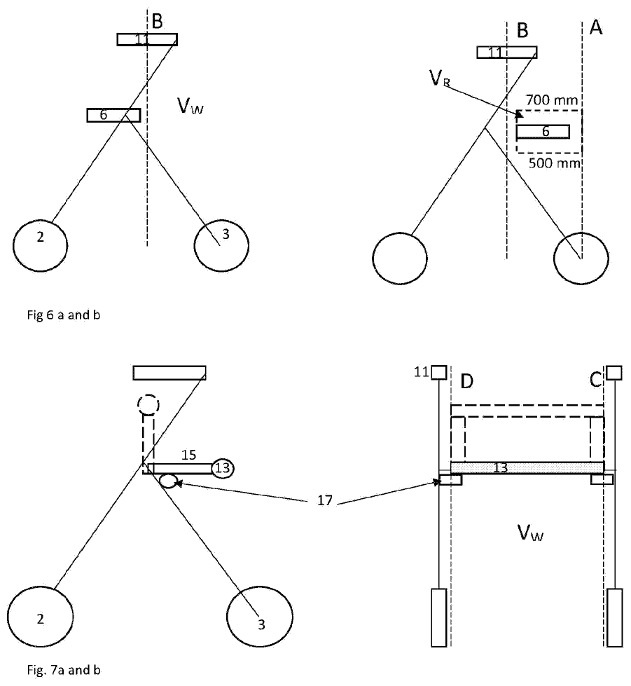

Through experiments and testing we have found that the one or more stowable rise-up structures (6) must be positioned, when extended, within a volume defined by (see FIG. 6b):
Higher than 45 cm above the floor.
Lower than 75 cm above the floor.

In front of a vertical plane A (FIG. 6) extending from the center of rear legs/wheels of the rollator.

Rearward of a vertical plane B going through the walking handles 11 centers.

Inside of vertical planes C and D, which are 3 cm on the inside of a vertical plane extending from the center of the rear leg/wheel and the front wheel on each side of the rollator.

We call this volume the rise-up structure volume (V_{R}). The rise-up structure 6 should be stowed in a position consistent with unhindered walking. FIG. 6a shows a stowed position and FIG. 6b shows an active position. The position of the rise-up structure 6 is fairly independent of the size of the user because the initial position of the user is sitting in a chair.

In an embodiment the rise-up structure volume is further limited by being higher than 55 cm above the floor and lower than 70 cm above the floor, more preferably higher than 60 cm above the floor and lower than 65 cm above the floor.

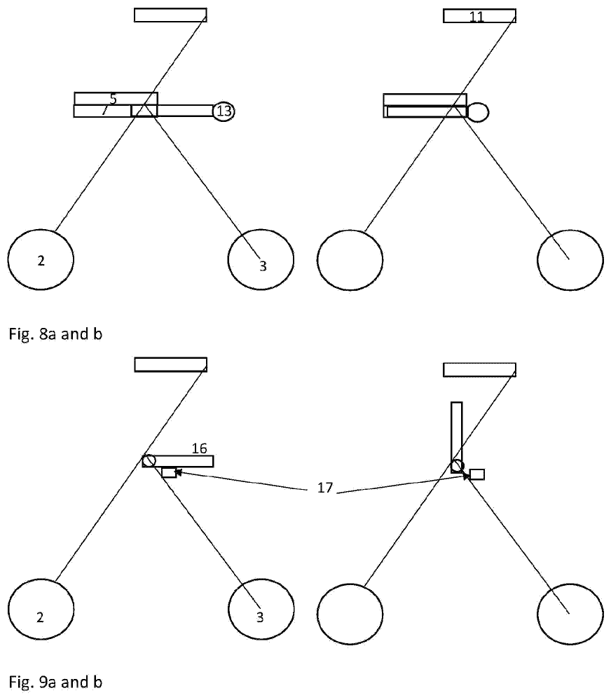

To define possible stowing positions for the rise-up structure we define a walking volume (VW), which is the volume that needs to be available for a user to achieve unhindered walking (see FIGS. 6a and 7b). The walking volume, VW, is defined by being:

Rearward of the vertical plane B stretching from the center of two walking handles 11.

Inside of vertical planes C and D, which are 3 cm on the inside of a vertical plane extending from the center of the rear leg/wheel and the front wheel on each side of the rollator.

The height restrictions for the walking volume is obviously the entire height of the rollator.

In one embodiment, seen in FIGS. 7a and b, the rise-up structure 6 is a foldable rise-up bar 13 stretching horizontally from side to side within the rise-up structure volume, V_{R}, as seen in FIG. 7 a and b. Preferably the rise-up bar 13 is connected to a folding arm 15 on each side which is rotatably connected to the frame. The bar is folded upward in a stowed position and is folded down to rest against the frame by means of a blocker unit 17. It is also conceivable to mount the rise-up bar 13 on two telescopic arms as indicated in FIGS. 8a and b.

In another embodiment, seen in FIGS. 1a and b, the rise-up structures 6 is a stowable rise-up handle 16 on each side of the mentioned volume. The rise-up handles can be moved between the two positions by means of a telescopic structure 7. It is also conceivable to use some kind of folding arrangement, as seen in FIGS. 9a and 9b, but such an arrangement may be a lot bulkier and is not considered optimal for a lightweight indoor rollator. At the outer end of the rise-up handle a gripping structure is provided in the form of a notch or gripping ring to enable the user to extend the rise-up handle to an active extended position as seen in FIG. 2.

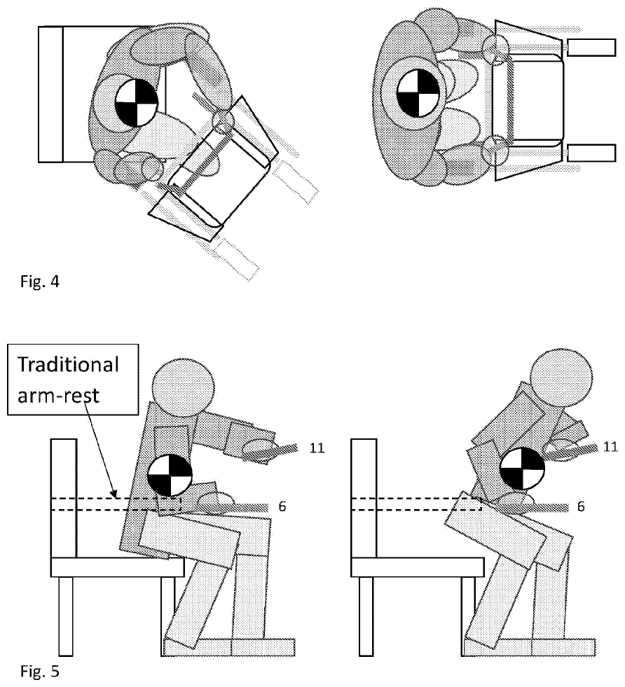

In a preferred embodiment telescopic structure 7 of the rise-up handle 16 is provided with a click-in mechanism holding the rise-up handle in the retracted and the extended position. A well-known click-in mechanism is spring tensioned ball partly entering a hole which is slightly smaller than the ball as indicated in FIG. 3.

The rise-up structures should be positioned at the same height or just below an ordinary arm rest of a chair. This will normally be at a height of 40-70 cm above the floor, more preferred 55-65 cm above the floor. Usually, a light weight, indoor rollator will have a crossbar 12 between the walking handles as seen in FIG. 1. We find that a vertical plane going through the center of a grip-zone of the rise-up structure 6 or rise-up handles 16 must be 8 cm rearward of a vertical plane going through the crossbar 12. This is equivalent to saying that the space between the walking handles 11 should be free from structures of any kind. This is necessary because when using the rise up handles for rising up the user will lean forward to keep the point of gravity above the feet, and the shoulder, chest and head will then easily knock into any structures positioned between the walking handles.

For the rise-up structures to function well, at least the rear wheels 3 of the rollator must be locked when the rise-up handle is in use. This can be achieved with a parking brake system or the rollator can have an inverse brake system, which means that the brakes are always on unless a bar or handle is held in a certain position. In this text we consider the inverse system to be a kind of parking brake.

By placing the rollator at an angle to the chair as indicated in FIG. 4, the user can get support from a rise-up handle with one hand, and the walking handle 11 with the opposite hand as shown in FIG. 5. In this way the rollator can provide support in a similar manner as a chair with armrests can. This can enable some users to continue using the chairs, sofas or toilets they have in their homes, that may not have armrests. Some of the smaller users in the range for which the product is designed will still be able to, if desired, to place both hands on the rise-up handles in order to reach a standing position. Users with further reduced strength than the ones described above are advised by therapists to use both hands on the chair's armrests. Using the two rise-up handles is thought to be an alternative when armrests are not present.

### INVENTORY

1 Rollator
2 Front wheel
3 Rear wheel
4a and b rollator sides
5 Bridging structure
6 Rise-up structure
7 Telescopic structure
8 Gripping structure
8a Gripping ring
8b Gripping notch
9 Spring
10 Ball
11 Walking handle
12 Crossbar
13 Rise-up bar
15 Folding arm
16 Rise-up handle
17 Blocker unit

1. An indoor rollator having front and rear wheels and walking handles with free space between the walking handles and having wheels with a parking brake at a rear or rear legs, wherein one or more stowable rise-up structures are positioned, when extended in an active position, within a rise-up structure volume, V_{R}, defined by:
higher than 45 cm above a floor,
lower than 75 cm above the floor,
in front of a vertical plane A extending from a center of rear legs/rear wheels of the rollator,
rearward of a vertical plane B stretching from a center of two walking handles, and
inside of vertical planes C and D, which are 3 cm on an inside of a vertical plane extending from the center of a rear leg/rear wheel and a front wheel on each side, and
wherein the one or more stowable rise-up structures are positioned, when stowed in a retracted position, outside a walking volume, V_{W}, defined by being:
rearward of the vertical plane B stretching from the center of two walking handles,
inside of vertical planes C and D, which are 3 cm on the inside of a vertical plane extending from the center of the rear leg/rear wheel and the front wheel on each side.

2. The rollator according to claim 1, wherein the one or more stowable rise-up structures is a rise-up handle pointing rearward on each side of the rise-up structure volume.

3. The rollator according to claim 2, wherein each rise-up handle is extended by a telescopic structure.

4. The rollator according to claim 3, wherein the rise-up handles have a gripping structure for gripping the rise-up handles in order to extend the telescopic structure.

5. The rollator according to claim 2, wherein the rise-up handles are foldable.

6. The rollator according to claim 1, wherein the rollator is a four-wheel rollator comprising a frame with two rollator sides, each rollator side with a rear and a front wheel.

7. The rollator according to claim 2, wherein the rise up handles are mounted on a bridging structure holding two rollator sides together.

8. The rollator according to claim 1, wherein the one or more stowable rise-up structures is a rise-up bar stretching from side to side within the stowable rise-up structure volume.

9. The rollator according to claim 8, wherein the rise-up bar is attached to a folding arm on each side.

10. The rollator according to claim 1, wherein the rise-up structure volume is further restricted by being higher than 55 cm above the floor and lower than 70 cm above the floor.

11. The rollator according to claim 6, wherein the rise up handles are mounted on a bridging structure holding the two sides together.

12. The rollator according to claim 10, further restrict by being higher than 60 cm above the floor and lower than 65 cm above the floor.
